(19) United States
(12) Patent Application Publication
(10) Pub. No.: US 2019/0311642 A1
(43) Pub. Date: Oct. 10, 2019

(54) SYSTEM AND METHOD FOR LEARNING AND ASSESSMENT IN A CLASSROOM ENVIRONMENT

(71) Applicant: Extramarks Education India Pvt Ltd, Noida (IN)

(72) Inventors: Atul Kulshrestha, Noida (IN); Swagata Roy, Noida (IN)

(21) Appl. No.: 16/144,542

(22) Filed: Sep. 27, 2018

(30) Foreign Application Priority Data
Apr. 6, 2018 (IN) 201811013307

(51) Int. Cl. G09B 5/12; G09B 5/14; G06F 17/24; G06F 17/30

(52) U.S. Cl. CPC G09B 5/125; G06F 17/30165; G06F 17/241; G09B 5/14

(57) ABSTRACT

A smart classroom environment facilitates real-time activities to enhance the learning standards. The smart classroom system includes an interactive board, smart devices, a classroom server, and a main server that are interconnected through a communication network. Attendance is automatically registered when the attendee logs onto the smart device. The instructor can edit the attendance of the attendees in the instructor device based on pre-defined events of discontinuance of the attendees from the classroom. Further, the instructor can display and annotate documents stored in the instructor device on the interactive board in real-time. The annotated document can be shared with the attendees in the classroom. The system allows the control and coordination of the interactive board, smart devices, and the servers to deliver an interactive setup in the classroom and facilitates the information transmission to and from the attendees.

### FIELD OF THE INVENTION

The present invention relates to an e-learning classroom management system for delivering real-time instructions, specifically to a method and a system for monitoring real-time student attendance and real-time document sharing.

### BACKGROUND OF THE INVENTION

Traditionally, the use of information technology in classrooms and presentation halls is limited to the use of overhead projector for presentation slides. Better equipped smart classrooms conventionally provide LED projectors to play multimedia content from an external source like laptops, personal computers, etc. Moreover, such smart classrooms are equipped with high-end hardware such as laptops, personal computers, boards, projectors, tablets etc. that are connected through distributed networks and servers that helps in effectively carrying out daily classroom activities in an automated manner.

However, in existing smart classrooms, the instructors' have to track the attendance manually for each class in an attendance register. The instructors have to spare time for recording the class attendance. The task of recording the attendance becomes tedious for an instructor wherein there are large number of attendees in a class. Also, situations wherein an instructor has to deliver instructions in multiple classes makes it cumbersome for the instructor to individually track attendance for each class, thereby increasing the chances of manual errors in recording the attendance.

Parents may also want to be more involved with their children's education. However, parents may not always have easy access to their children's activities and performance in the classroom and may not have an easy means of communication with the instructors.

Therefore, there is a need of automatic attendance system to save the precious time of instructors and attendees while providing the facility to update and interact with the parents about their child's activities and progress in the school.

Also, there is a need for a system to enable instructors to create and manage learning content easily and to be able to control the content while displaying to the attendees. The attendees need to interactively learn in the classroom through various activities and thereby eliminating the need to carry heavy bags to the school.

A well-customized system is required to provide education that is individually tailored to meet the individual's needs and learning styles may benefit the attendees to a great extent as each attendee has a unique learning style. The instructors generally know what each individual attendee needs in order to improve his/her progress in the classroom, but instructors often lack the time and resources to create individualized teaching plans for each attendee.

### SUMMARY OF THE INVENTION

The present invention provides a dynamic learning environment to the attendees through an enriched classroom tablet program, thus automating the teaching process using state of art technology and get the attendees' experience the latest learning mode. Users can easily connect to the session through their designated devices to participate in the classroom and ensure a seamless working experience at home as well. The instructor stays in control, using the designated device to teach the session, take attendance, give homework, make notes etc. Additionally, the instructor is given the ability to both monitor and control what the attendees do with their device.

In an embodiment, a system for learning and assessment in a classroom is described. A main server is connected to the plurality of classroom servers wherein at least one of the plurality of classroom servers is connected to the main server. There is a plurality of smart devices wherein at least one of the plurality of smart devices is associated with an instructor and one or more attendees, wherein at least one of the smart devices is connected to the classroom server; and an interactive board connected with at least one of the plurality of smart devices to display one or more documents, wherein at least one of the document is shared with at least one of the plurality of smart devices associated with one or more of the attendees of the classroom. The classroom is equipped with interactive board which is featured with real-time document annotation and the annotated document can be shared with attendees.

In another embodiment, a method for learning and assessment in a classroom is described. Recording of the attendance of one or more attendees in an instructor device is done wherein the plurality of attendees logs onto the associated smart devices in the classroom by logging in to the classroom server network. The attendance is recorded at the beginning of the class and is presented in the form of a list on the instructor's device as soon as the attendee logins through their device. Additionally, the invention enables an instructor to edit the attendance of one or more of the attendees in the instructor device by the instructor based on pre-defined events of discontinuance of the attendees from the classroom. Moreover, the instructor is enabled to annotate a plurality of documents stored in the instructor device, wherein the instructor is enabled to annotate the documents displayed on the interactive board in real-time and the annotated document is shared with the plurality of smart devices associated with one or more of the attendees of the classroom.

### BRIEF DESCRIPTION OF THE DRAWINGS

The invention has other advantages and features which will be more readily apparent from the following detailed description of the disclosure and the appended claims, when taken in conjunction with the accompanying drawings. Different numeral references on figures designate corresponding elements. The same numbers are used throughout the drawings to reference like features and components. The detailed description is described with reference to the accompanying figure(s).

FIG. 1 depicts block diagram illustrating an embodiment of the classroom tablet program system.

FIG. 2 depicts flow chart illustrating process of recording attendance, content launch on interactive board, document annotation, and homework and assessment modules.

FIG. 3 depicts flow chart illustrating process of stopping class by the instructor.

### DETAILED DESCRIPTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The invention in its various embodiments proposes a system referred to as “Classroom tablet program” (CTP). A main server is connected to the plurality of classroom servers wherein at least one of the plurality of classroom servers is connected to the main server. There is a plurality of smart devices wherein at least one of the plurality of smart devices is associated with an instructor and one or more attendees, wherein at least one of the smart devices is connected to the classroom server; and an interactive board connected with at least one of the plurality of smart devices to display one or more documents, wherein at least one of the document is shared with at least one of the plurality of smart devices associated with one or more of the attendees of the classroom. The classroom is equipped with interactive board which is featured with real-time document annotation and the annotated document can be shared with attendees.

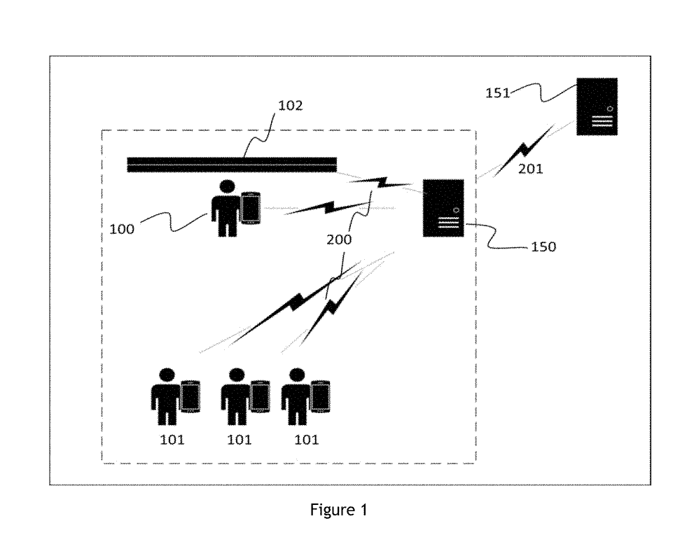

Referring to FIG. 1, which describes a classroom environment that comprises of an instructor device 100, the student devices 101, the classroom server 150, the interactive board 102, the main server 151; the instructor device, attendees' devices and the interactive board exchange data via wireless or wired network 200 with classroom server 150 and the classroom server 150 exchange data via wireless or wired network 201 with main server. The servers may act as routing device. The instructor and attendees' devices are preferably smart devices in the embodiment of the present invention, may comprise, for example, smart phone, tablet, phablet, laptop, personal digital assistant (PDA) and the like. The instructor's device 100 and attendees devices 101 comprises a memory, a processor, a touch sensitive display module, an audio module, radio frequency (RF) module, battery and the like. These components communicate with each other via communication buses. Other than pre-installed applications, the memory is used to store software programs of the CTP and other educational content; the processor runs software programs stored in the memory to perform the application functions and data processing functions. The RF module helps in transmitting and receiving data so as to communicate with other devices and server via the network 200. The audio module provides an audio interface to the user.

The touch screen of the instructor's device 100 and attendees' devices 101 also provides a user interface input and output. Specifically, the touch screen displays the users a specific teaching media that may include text, graphics, video, and any combination thereof. Network 200 is configured to couple one smart device with another smart device. Networks 200 and 201 may include internet in addition to LAN, wired wide area networks (WANs), wireless WANs via Wi-Fi, Bluetooth, satellite, modem or telephone link, wired connections, such as through an Ethernet port or a universal serial bus (USB) port. Networks 150 and 151 may further employ a plurality of satellite communication technologies including 2G, 2.5G, 3G, 4G and the like future generations.

The users may be required to register the devices before getting access to the CTP module. The registration of the smart devices with the main server comprises:

a) The smart device entering the coverage area of the main server Wi-Fi;
b) Launching and executing CTP application in the mobile computing device;
c) The smart device connecting to the CTP infrastructure;
d) The main server recognizing the smart device is not yet registered and instructing the user to prompt for registration.
During registration, the main server may save the device MAC ID, user type, school ID and user details such as name, class, section, etc. It is required for the user to login from the main server for the first time for user authentication. The device MAC ID is registered against the login credentials provided by the user.

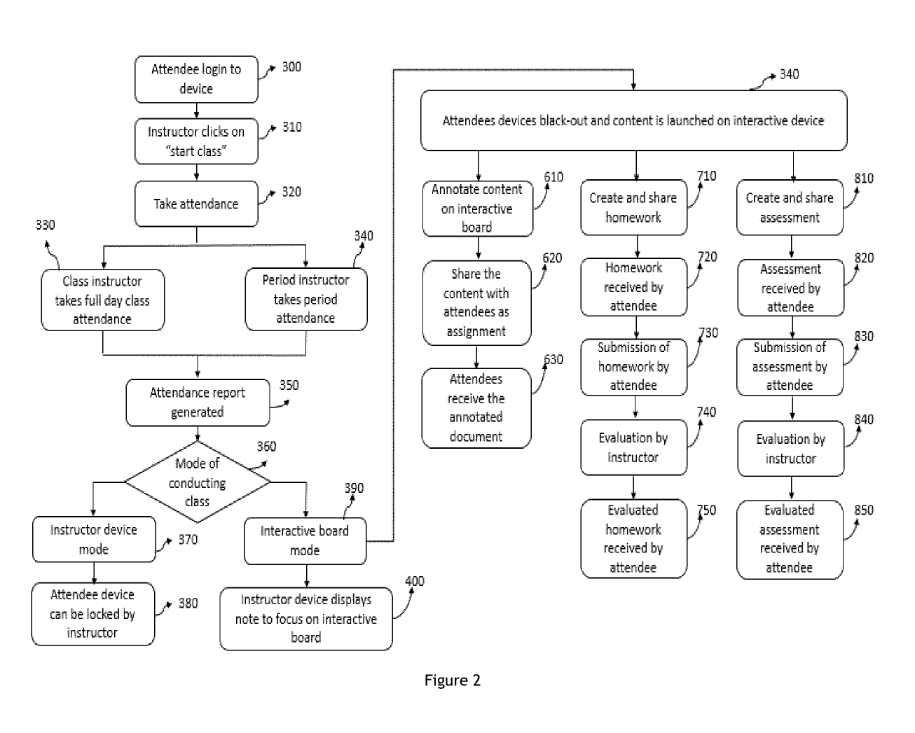

Referring to FIG. 2, when the attendee logs 300 onto the device, the instructor can input the start command 310 on his/her device's touch panel and records attendance 320, wherein after the classroom server 150 automatically tracks the attendance of the attendees by the device's MAC ID. The attendance data is then further sent to the main server 151. The class instructor records full-day attendance 330 of the class which is one-time activity and the period instructor records period attendance 340 of that particular period. The class instructor may be able to see period attendance of the attendees for all the periods whereas the period instructor may be able to see his/her own period attendance and not for any other periods. The date and time of each login of the attendees will be tracked and reports are generated 350 of when and how many times an attendee has logged in to the application. If the user logs in the offline mode, the application authenticates the users through the offline variables.

Attendance reports 350 may be generated at any time from the application using the report module. The report module can access the data in the application database, or any other host databases, to generate reports that highlight trends in student attendance for a variety of comparative factors including trends for particular students or particular groups, trends by periods. As a result, report module can produce a wealth of attendance information aggregated across wide variations in date and subject-wise periods. The reports may be exported into different types of file formats like comma-separated values, Portable Document Format (PDF), HTML table, Microsoft excel, tab-separated values, XML format or any other customized data formats.

The attendance is maintained in the database of main server. The database is used for data storage of information related to attendance data, login and logout time data, and the like. The database can represent multiple datasets and can be used for the storage of a variety of data in support of the Classroom tablet program.

Real time notifications will update the instructor about attendees class presence. Due to any reason, if an attendee discontinues a particular period during the lecture, a notification appears on the instructor's screen intimating about the attendees discontinuation of the class with the name of attendee. However, this will not impact attendance status of the attendee. The attendee will not be able to edit his/her own attendance status. The attendee has option to refresh the attendance to check his/her latest status.

The instructor is allowed to edit the status of attendance from absent to present during the following pre-defined events:

a) Attendee's tab device not working.

b) Attendee has joined the class late.

c) Attendee has discontinued the class.

d) Any indefinable circumstances.

If the attendance of full-day class mismatches with any of the period attendance, the class instructor and period instructor receives a notification about the mismatch with the list of student names.

The interactive board 102 is an electronic touch sensitive screen. The lecture will be launched on interactive board 102 by default. The instructor may choose to switch to device or continue using interactive board any time as per his/her own teaching requirements. If the instructor chooses interactive board mode 390, the screens of attendee's devices turns into ‘black-out’ mode and the content is launched 410 on interactive board. In black-out mode, the attendee's device displays black screen and in black-in mode, the attendee will be able to use the device.

If the session is conducted from instructor device mode 370, the instructor can lock or unlock 380 the attendees' devices. The screens of the attendees' device may be controlled by instructor in lock mode whereas, in unlock mode, the attendee may pursue study at his/her own pace; however, the attendee may browse through other services of the application.

When the instructor starts the period from the device, the attendees receive notification on their device that the class is about to start along with the instructor's name. The instructor can exercise various controls from ‘Right Flyer Menu’ which facilitates lock/unlock, mute/unmute and black out/black in. This feature is only available in instructor's device and not available on attendee's device.

Referring to FIG. 2, the instructor may be able to assign homework 710 by creating it either on the device or from the interactive board and may be able to attach different types of multimedia files like PPT, videos, audio file, word document and the like. The instructor can also create an annotated file 610 from the interactive board and sent it as assignment 620 to the attendees and the attendees receiving the document 630 with a notification. The instructor can create and share a homework file 710. After receiving the homework 720 by the attendee on the device, the attendee will be able to work and submit 730 the homework by answering it on their device or by attaching the homework file and upload. Instructor receives the submitted homework on the device and evaluates 740 with marks and remarks. The attendee receives the evaluated homework 750. Homework may be assigned to an individual, a group or a class.

The instructor would be able to see the list of assigned homework, list of submissions and pendency report. The attendee can view his/her submissions and corrected homework received with instructor's remarks on it. This operates in both online and offline mode. Homework creation, answering homework and corrections can be done in offline mode, but sending and receiving of the files may require online connectivity.

The application interface has a ‘daily diary’ to share circulars, notices and messages for regular communication of the instructor with the attendees, colleagues, a class, a group, an individual and with parents. The attendee can communicate with his/her class instructor or subject instructor only. It can be operated in both online and offline mode. In online mode messages are forwarded immediately, whereas in offline mode messages remains in sender's device and will be forwarded when connected with the main server.

The instructor's device is facilitated to create groups for assigning homework and projects, sharing notes and sending messages through daily diary and attendee can view only their group members in his/her device. Groups can be created on both online and offline mode.

The attendee can see only his/her group during online mode. Instructor can make different groups for a class. The instructor can make a group ‘inactive’ temporarily. A group automatically become ‘inactive’ incase all the attendees are removed from it. The attendees can only view the members of his/her own group.

The instructor can share ‘Notes’ with the attendees, a particular group and public. The instructor and attendees can create notes and share. The attendee can share notes with his/her class instructor and subject instructor only. Sharing of notes is possible in online mode only but can be created and saved in offline mode as well. Notes saved can be edited and can be sent as new notes. Notes can be shared publicly. Weblinks can be shared through notes. The instructor can share notes with class, group, individual and with public. The attendees can share notes with subject instructor or class instructor.

Referring to FIG. 2, the system facilitates assessment of attendees from pre-designed questionnaire from repository or quick on-the-spot assessments. When the instructor shares 810 the assessment test to the attendees, they will receive 820 real-time notification about the assessment on their device. When the attendee answers and submits 830 the assessment, the instructor receives a notification. The instructor evaluates 840 the submissions and result reports are stored in the main server and can be viewed 850 by the attendee. The instructor can track attendee-wise and class-wise performance record. The instructor can view status of submissions of each attendee. The attendee can view only his/her results. If in case, the device become non-responsive, the attendee is intimated on login screen that the class is in progress and automatically taken to the last state of the application.

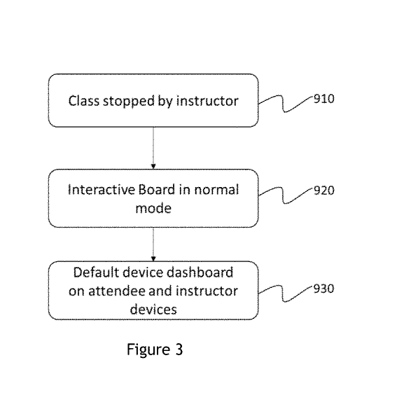

The instructors can stop the session from their device. Referring to FIG. 3, when the session is stopped 910 by the instructor, the interactive board displays normal mode 920 and the instructor's device and attendees' devices display default dashboard 930. Only one class for a particular section can be conducted at a time. For example, if 6A is started by an instructor, no other instructor will be able to start the class for 6A unless the first instructor stops the class.

The embodiments and implementations described above are illustrative examples and it should not be construed that the present invention is limited to these particular embodiments. Thus, various changes and modifications may be made by one skilled in the art without departing from the spirit or scope of the invention as defined in the appended claims.

We claim:

1. A system for learning and assessment in a classroom comprising:
a main server;
a plurality of classroom servers; wherein at least one of the plurality of classroom servers is connected to the main server;
a plurality of smart devices, wherein at least one of the plurality of smart devices is associated with an instructor and one or more attendees, wherein at least one of the smart devices is connected to the classroom server; and
an interactive hoard connected with at least one of the plurality of smart devices to display one or more documents, wherein at least one of the documents is shared with at least one of the plurality of smart devices associated with one or more of the attendees of the classroom.

2. The system as claimed in claim 1, wherein the smart device associated with the instructor is configured to facilitate assessment of one or more of the attendees, wherein the assessment is conducted from amongst a plurality of pre-defined questions stored in a pre-defined repository and obtain responses to at least one of the pre-defined questions.

3. The system as claimed in claim 1, wherein the smart device associated with the instructor is configured to receive a plurality of administrative instructions from the main server, wherein the smart device associated with the instructor is configured to send the plurality of administrative instructions to the plurality of smart devices associated with one or more of the attendees.

4. The system as claimed in claim 3, wherein the one or more documents are stored in the device of the instructor.

5. The system as claimed in claim 1, wherein the interactive board enables real-time annotations of one or more of the documents.

6. The system as claimed in claim 1, wherein at least one of the plurality of classroom servers is configured to record the presence of an attendee in the classroom.

7. The system as claimed in claim 5, wherein the smart device of the instructor is configured to mute or unmute at least one of the smart devices associated with the attendee.

8. The system as claimed in claim 5, wherein the smart device associated with the instructor is configured to lock or unlock at least one of the smart devices associated with the attendee.

9. The system as claimed in claim 5, wherein the smart device associated with the instructor is configured to create plurality of groups and assign tasks.

10. The system as claimed in claim 5, wherein the smart device associated with the instructor is configured to attach multimedia files and sharing with the plurality of attendees.

11. The system as claimed in claim 1, wherein the plurality of smart devices and each of the plurality of classroom server is connected through a wireless communication interface.

12. A method for learning and assessment in a classroom comprising steps of:
recording the attendance of a one or more of attendees in an instructor device wherein the plurality of attendees logs onto the associated smart devices in the classroom;
editing the attendance of one or more of the attendees in the instructor device by the instructor based on pre-defined events of discontinuance of the attendees from the classroom; and
annotating a plurality of documents stored in the instructor device, wherein the instructor is enabled to annotate the documents displayed on the interactive board in real-time and the annotated document is shared with the plurality of smart devices associated with one or more of the attendees of the classroom.

13. The method as claimed in claim 12, wherein the pre-defined events of discontinuance of the attendees from the classroom includes malfunctioning of the smart devices associated with one or more of the attendees, delay in joining the class by the attendee, and discontinuance of the class by the attendee.

14. The method as claimed in claim 12, wherein attendance of each of one or more of the attendees is configured to be editable from at least one of a present to an absent and from an absent to a present.

15. The method as claimed in claim 12, wherein the instructor is enabled to annotate the documents displayed on the interactive board.

16. The method as claimed in claim 12, the sharing of the annotated document with the plurality of smart devices associated with one or more of the attendees of the classroom is through a wireless communication network.
